(19) United States
(12) Patent Application Publication
(10) Pub. No.: US 2003/0105758 A1
(43) Pub. Date: Jun. 5, 2003

(54) System and method for testing and promoting database update code

(75) Inventor: John Kliewe, Stamford, CT (US)

Correspondence Address: Joseph T. Van Leeuwen, P.O. Box 81641, Austin, TX, 78708-1641, US

(73) Assignee: International Business Machines Corporation, Armonk, NY

(21) Appl. No.: 10/005,140

(22) Filed: Dec. 5, 2001

(51) Int. Cl. G06F 7/00

(52) U.S. Cl. 707/9

(57) ABSTRACT

A system and method for testing and promoting database update code is presented. A programmer uses a SPUFI machine that enables him to test SPUFI code on error prone data that is copied from a customer's actual database. The SPUFI machine sends an access request to the customer prior to copying the actual database. Once the programmer has the SPUFI code working properly, the SPUFI machine sends the SPUFI code to a staging area. The staging area does not allow code changes prior to executing the SPUFI code on the customer's actual database. The customer is informed whether the SPUFI code corrects the actual database.

### BACKGROUND OF THE INVENTION

1. Technical Field

The present invention relates in general to a system and method for testing and promoting database update code. More particularly, the present invention relates to a system and method for testing code with actual data and ensuring the code does not change while promoting it to the production environment.

2. Description of the Related Art

Databases are used throughout business environments to store vast amounts of information. Some databases include proprietary company information and are considered highly confidential. Other databases may include widely known information and are accessible to everyone.

Databases may include information stored in records. For example, a credit card company database may include information about each customer and organized in records. Each record may include the customer's name, address, credit history, and spending limit. In this example, the database may be considered highly confidential since the credit card company may not want personal information about its' customers to be available to the general public.

Occasionally, it is determined that a database includes erroneous data in various records. The programmer may use Structured Query Language (SQL) to correct the data. SQL is a standardized language for defining and manipulating data in a relational database. In accordance with the relational model of data, the database is perceived as a set of tables. Relationships are represented by values in tables, and data is retrieved by specifying a result table that may be derived from one or more tables. DataBase 2, or DB2, is a family of relational database products. DB2 transforms the specification of a result table into a sequence of internal operations that optimize data retrieval. This transformation occurs when an SQL statement is prepared.

Executable SQL statements are prepared before they can be executed. The result of preparation is the executable or operational form of the statement. The method of preparing an SQL statement and the persistence of its operational form distinguishes static SQL from dynamic SQL.

Programmers use SPUFI (SQL Processor Using File Input) as a brute force method of fixing data. SPUFI processes SQL statements that are not embedded in a program. It is especially useful for granting an authorization or creating a table when a host language is not necessary and for testing statements that are embedded in a program.

The owner of the database may want assurance that the erroneous record modifications are successful and that the SPUFI program does not alter other records of the database. Therefore, the database owner may require a database administrator to execute the SPUFI program step-by-step to ensure success. A challenge found with database administrators performing this task is that using database administrators for step-by-step code execution may be a poor use of resources since database administrators are typically highly paid and highly skilled.

SPUFI code is written to execute using a specific set of data. Therefore, the actual erroneous records must be used to effectively test and debug the SPUFI code. A challenge found in using the erroneous records is that they are located on a customers' active database. This poses a risk to the database in that if the SPUFI code is not accurate on the first execution, data may be changed in the database that should not be changed.

A programmer may make small programming changes (“tweaks”) to code after he has debugged the code in background in order to prepare the code for the production environment. A challenge found with making “tweaks” after code debugging is ensuring that the “tweaks” do not change the results of the debugging.

What is needed, therefore, is a way to minimize the risk of testing code on actual data and ensuring the code operates correctly before using in the production environment.

### SUMMARY

It has been discovered that SPUFI code may be tested using actual data with minimum risk and ensuring no code changes during the production transition by using a SPUFI machine. The SPUFI machine builds a mini-test environment that emulates the production environment. A programmer uses the SPUFI machine to test and debug the code. When the code is ready for production implementation, the SPUFI machine sends the code to a staging area, ensuring that the code is not modified after final code debugging.

A customer determines that he has erroneous records in a database. The customer utilizes a programmer to write a SPUFI code to correct the records. The programmer writes the SPUFI program to correct the erroneous records and sends the program along with a database access request to the SPUFI machine. The SPUFI machine sends the database access request to the customer. If the customer approves the access request, the SPUFI machine copies the erroneous database to a copy store area.

The SPUFI machine executes the SPUFI code against the copied erroneous database, resulting in a changed database. The changed database is analyzed for correctness. The programmer has the ability to modify the SPUFI code during the debugging process until the changed database is correct.

Once the SPUFI code performs correctly, the SPUFI machine sends a request to the customer to modify the actual erroneous records located on the actual database.

If the customer approves the modification request, the SPUFI machine backs up the actual database. The database backup is performed in case the SPUFI code incorrectly modifies the actual erroneous database, in which case the database may be recovered from the backup database.

The SPUFI machine copies the SPUFI code into a staging area that ensures that the code is not modified during the production implementation transition. The SPUFI machine updates the actual database using the SPUFI code in the staging area. The database modifications are validated and a notification is sent to the customer. If the modifications are not correct, the customer has the option of recovering the database from the backup storage area.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram of a SPUFI machine testing and updating code;

FIG. 2 is a high-level flowchart showing a customer requesting a code change and a programmer updating the code;

FIG. 3 is a flowchart showing a programmer requesting approval to access customer data;

FIG. 4 is a flowchart showing code tested and debugged;

FIG. 5 is a flowchart showing code used on active data and results verified; and

FIG. 6 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

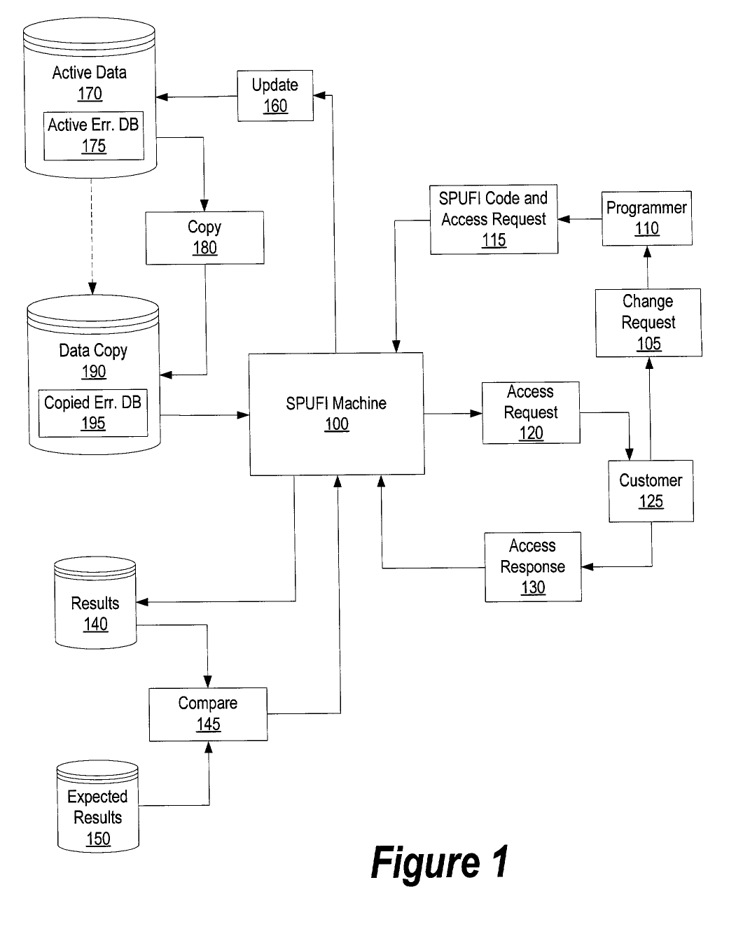

FIG. 1 is a diagram of a SPUFI machine testing and updating code. Customer 125 determines that he has an erroneous database located in active data store 170. Active data store 170 may be a non-volatile storage area, such as a computer hard drive. Customer 125 sends change request 105 to programmer 110 that includes information about erroneous database 175.

Programmer 110 writes a SPUFI program to correct erroneous database 175. Programmer 110 sends SPUFI code and database access request 115 to SPUFI machine 100. SPUFI machine 100 receives SPUFI code and database access request 115, and sends approval request 120 to customer 125. Approval request 120 includes a request for programmer 110 to access erroneous database 175 owned by customer 125.

Customer 125 sends approval response 130 to SPUFI machine 100. If customer 125 denies the access request from programmer 110, SPUFI machine 100 notifies programmer 110 and the programmer is not allowed to access erroneous database 175. On the other hand, if customer 125 approves programmer 110's request, erroneous database 175 is copied via copy process 180 to data copy store 190. Data copy store 190 may be a non-volatile storage area, such as a computer hard drive.

SPUFI machine 100 retrieves the copied erroneous database located in data copy store 190 and executes the SPUFI code against the copied erroneous database. SPUFI machine 100 stores the results in results 140. Results 140 may be a non-volatile storage area, such as a computer hard drive. Compare 145 process compares the results located in results 140 with expected results by programmer 110 located in expected results 150. SPUFI machine 100 analyzes the comparison and informs the programmer of the results. The programmer may debug the SPUFI code and rerun it against copied erroneous database 195. The programmer may continue to debug the code without interfering with erroneous database 175 located within active data store 170.

Once compare process 145 indicates that results 140 are comparable to expected results 150, SPUFI machine 100 sends approval request 120 to customer 125. Approval request 125 includes a request to access and modify erroneous database 175 located within active data 170. Customer 175 sends approval response 130 to SPUFI machine. If customer 175 does not approve of the access and modification, SPUFI machine notifies programmer 110 and erroneous data 175 is not accessed.

On the other hand, if customer 125 approves of the access and modification, SPUFI machine backs up erroneous database 175 as copied erroneous database 195 located within data copy 190 via copy 180. This copy is performed in case the SPUFI update to erroneous database 175 is not successful, in which case copied erroneous database 195 is copied back to active database 170.

SPUFI machine 100 updates erroneous database 175 via update 160 using the identical SPUFI code that was used in modifying copied erroneous database 195. The database modification results are validated to ensure that the database modification was successful.

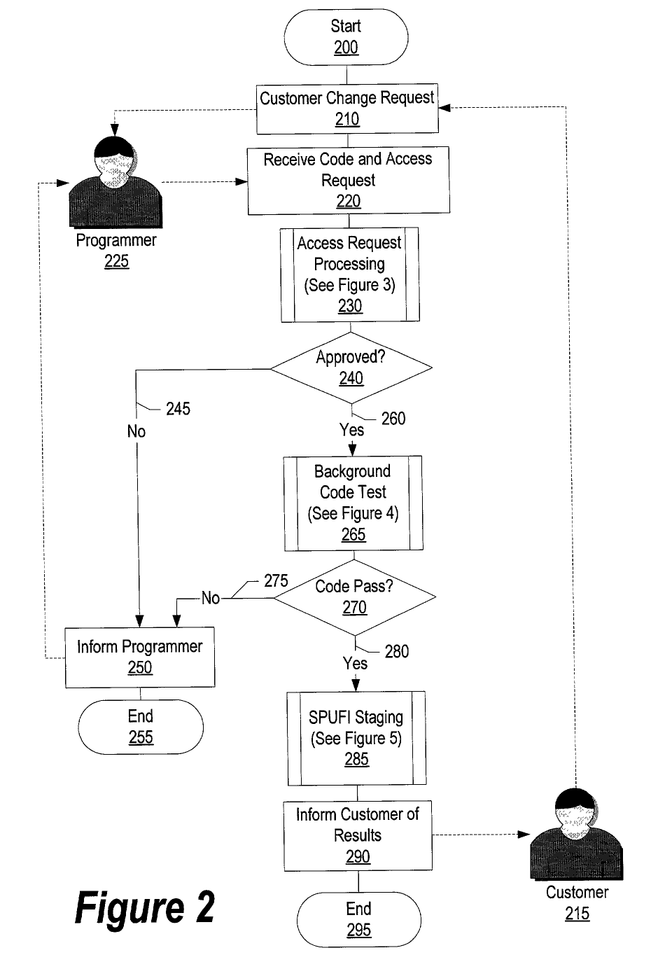

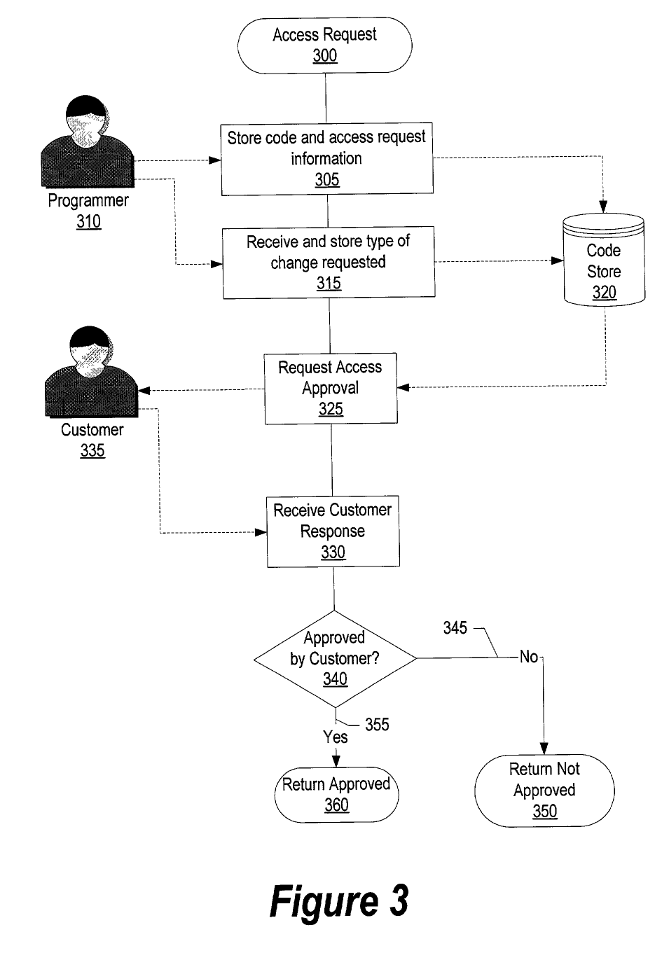

FIG. 2 is a high-level flowchart showing a customer requesting a code change and a programmer updating the code. Processing commences at 200, whereupon customer 215 requests a database change to programmer 225 (step 210). Programmer 225 verifies the need for a database update. If programmer 225 determines that the database needs an update, programmer 225 writes a SPUFI program and sends the program and a database access request at step 220. The access request is processed which includes a request for programmer 225 to access the active erroneous database owned by customer 215 (pre-defined process block 230, see FIG. 3 for further details).

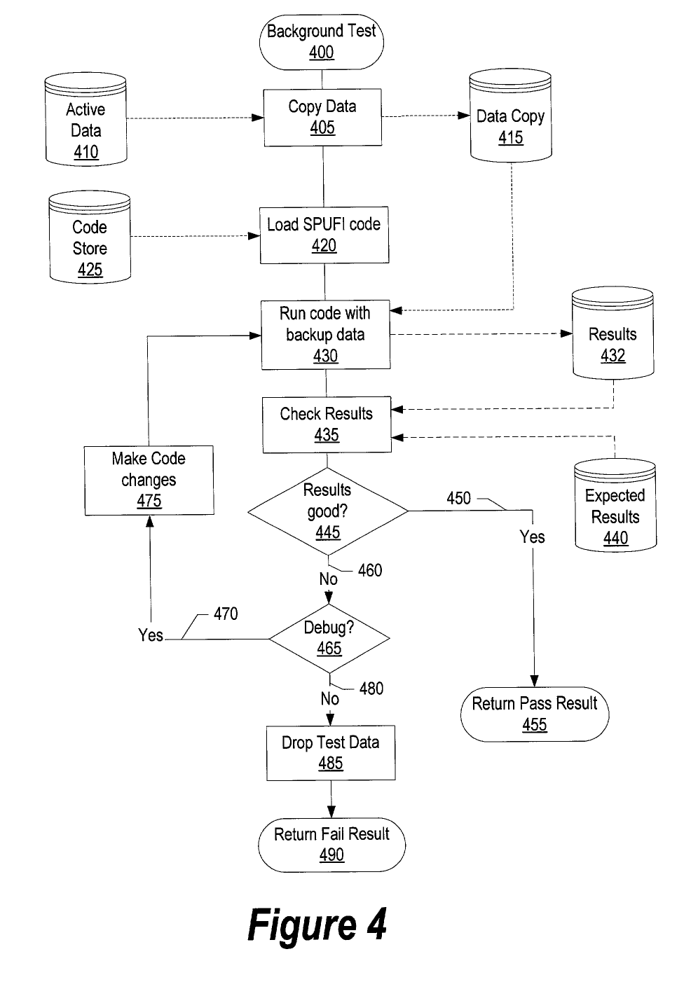

A determination is made as to whether customer 215 approves access of the active erroneous database by programmer 225 (decision 240). If the customer does not approve access of the active erroneous database by programmer 225, decision 240 branches to “Nof” branch 245 whereupon programmer 225 is informed at step 250 and processing ends at 255. On the other hand, if customer 215 approves, decision 240 branches to “Yes” branch 260 whereupon the SPUFI code is tested in background (predefined process block 265, see FIG. 4 for further details).

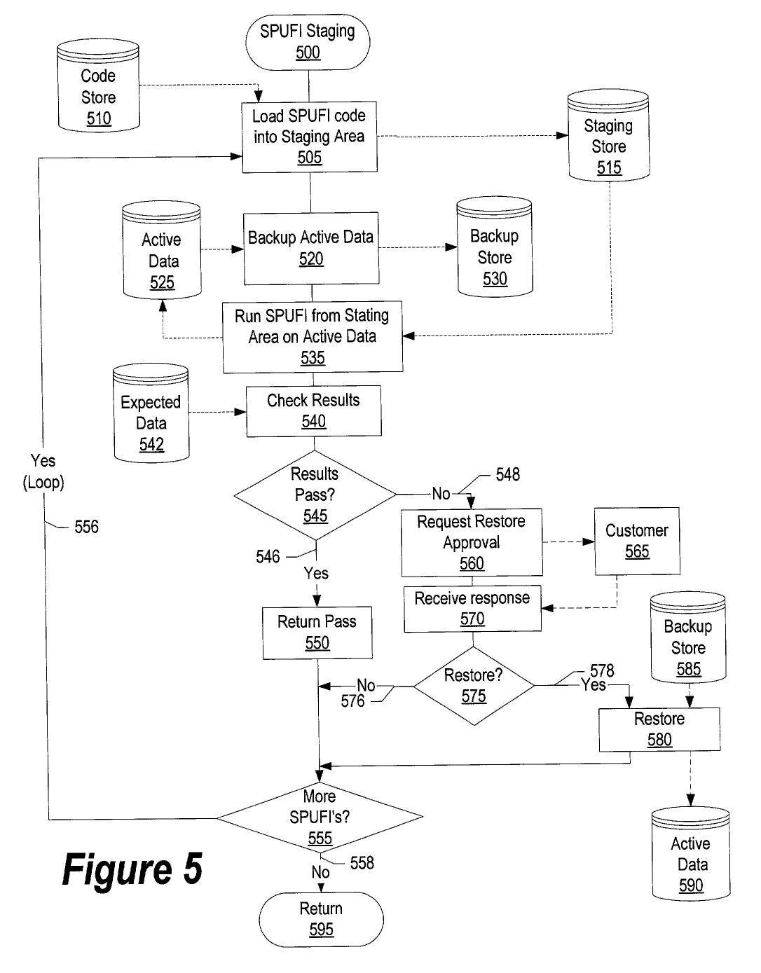

A determination is made as to whether the SPUFI code passed in background testing (decision 270). If the code did not pass background testing, decision 270 branches to “No” branch 275 whereupon programmer 225 is informed (step 250) and processing ends at 255. On the other hand, if the code passes background testing, decision 270 branches to “Yes” branch 280 whereupon the SPUFI code is tested on the active erroneous database (pre-defined process block 285, see FIG. 5 for further details). Customer 215 is informed of the test results on the active erroneous database at step 290, and processing ends at 295.

FIG. 3 is a flowchart showing a programmer requesting access to an active erroneous database. Processing commences at 300, whereupon SPUFI code and a database access request are received (step 305) from programmer 310 and stored in code store 320. A change type is received from programmer 310 and stored in code store 320 at step 315. The change type may be updating a record, deleting a record, inserting a record, or replacing a record. For example, the active erroneous database may include multiple outdated records. Programmer 310 may determine that the best approach is to update each record instead of deleting the outdated records and inserting new records.

A request to access the active erroneous database is sent to customer 335 at step 325. Processing receives a response from customer 335 at step 330. The customer response may be in the form of a digital signature or other response method.

A determination is made as to whether customer 335 approves of programmer 310's access of the active erroneous database (decision 340). If the customer approves of such access, decision 340 branches to “yes” branch 355 and processing returns an approval at 360. On the other hand, if customer 335 does not approve of such access, decision 340 branches to “No” branch 345 whereupon processing returns a “not approved” response at 395. For example, customer 335 may know of additional changes with the active erroneous database and may want time to analyze the issues and have the programmer 310 correct all the records at once.

FIG. 4 is a flowchart showing testing and debugging SPUFI code in background. Processing commences at 400, whereupon an active erroneous database is copied (step 405) from active data store 410 to data copy store 415. The active erroneous database is copied so the programmer may test and debug his SPUFI code on actual data without disrupting the active database located within active data 410. Active data store 410 and data copy store 415 may be stored on non-volatile storage areas, such as computer hard drives.

The SPUFI code is loaded from code store 425 at step 420. The SPUFI code is executed using the copied erroneous database located in data copy 415 (step 430) resulting in a changed database which is stored in results 432. The changed database is compared (step 435) to expected results located in expected results 440.

A determination is made as to whether the changed database is correct (decision 445). If the database change results in correct data, decision 445 branches to “Yes” branch 450 and a pass result is returned at 455. On the other hand, if the database change is not successful, decision 445 branches to “No” branch 460 and a determination is made as to whether to debug the SPUFI code (decision 465).

If the programmer chooses to debug the SPUFI code, decision 465 branches to “yes” branch 470. The programmer makes SPUFI code changes at step 475, and processing loops back to process the revised code. This looping can be performed multiple times until the database results are correct. On the other hand, if the programmer chooses not to debug the SPUFI code, decision 475 branches to “No” branch 480 and the changed database is removed from results 432 at step 485 and a fail result is returned at 490.

FIG. 5 is a flowchart showing SPUFI code changing active data and verifying the changes. Processing commences at 500, whereupon the SPUFI code is loaded from code store 510 to staging store 515 (step 505). The active erroneous database is copied (step 520) from active data 525 to backup store 530. The active erroneous database is copied to ensure that the database may be recovered if the SPUFI code corrupts the active erroneous database. The SPUFI code located in staging store 515 is executed with the active database located in active data 525 resulting in a changed active database (step 535).

Changed active database 525 is compared to expected results database 542 (step 540). The expected results database includes information about what the changed database should include. For example, the SPUFI code may be designed to change four records. The expected results database includes information about the four records. A determination is made as to whether the changed active database is correct (decision 545). If the database changed successfully, decision 545 branches to “Yes” branch 546 whereupon a “pass” is returned at step 550. Using the example above, if it is determined that the four records changed successfully and nothing else changed, the update is considered successful.

On the other hand, if the database did not change successfully, decision 545 branches to “No” branch 548 and a request to restore the active database is sent to customer 565 (step 560). Using the example above, the SPUFI code may have changed five records, one more record than what should have been change.

A response is received from customer 565 at step 570 corresponding to the database restoration, and a determination is made as to whether customer 565 approves of the programmer restoring the database (decision 575). If the customer chooses not to have the programmer restore the database, decision 575 branches to “No” branch 576. On the other hand, if the customer chooses to have the programmer restore the database, decision 575 branches to “yes” branch 578 whereupon the backup erroneous database is copied from backup store 585 to active data 590 (step 580).

A determination is made as to whether there are more SPUFI codes to run in staging store 515 (decision 555). If there are more SPUFI codes to run, decision 555 branches to “Yes” branch 556 which loops back to process more SPUFI codes. This looping continues until there are no more SPUFI codes to process, at which point decision 555 branches to “No” branch 558 and processing returns at 595.

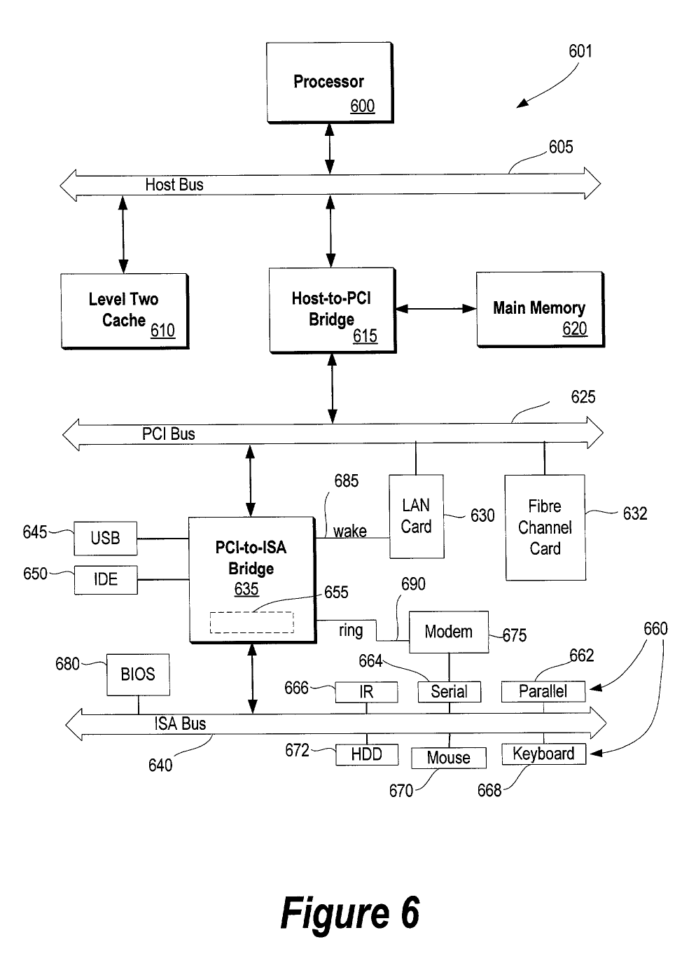

FIG. 6 illustrates information handling system 601 which is a simplified example of a computer system capable of performing the server and client operations described herein. Computer system 601 includes processor 600 which is coupled to host bus 605. A level two (L2) cache memory 610 is also coupled to the host bus 605. Host-to-PCI bridge 615 is coupled to main memory 620, includes cache memory and main memory control functions, and provides bus control to handle transfers among PCI bus 625, processor 600, L2 cache 610, main memory 620, and host bus 605. PCI bus 625 provides an interface for a variety of devices including, for example, LAN card 630. PCI-to-ISA bridge 635 provides bus control to handle transfers between PCI bus 625 and ISA bus 640, universal serial bus (USB) functionality 645, IDE device functionality 650, power management functionality 655, and can include other functional elements not shown, such as a real-time clock (RTC), DMA control, interrupt support, and system management bus support. Peripheral devices and input/output (I/O) devices can be attached to various interfaces 660 (e.g., parallel interface 662, serial interface 664, infrared (IR) interface 666, keyboard interface 668, mouse interface 670, and fixed disk (HDD) 672) coupled to ISA bus 640. Alternatively, many I/O devices can be accommodated by a super I/O controller (not shown) attached to ISA bus 640.

BIOS 680 is coupled to ISA bus 640, and incorporates the necessary processor executable code for a variety of low-level system functions and system boot functions. BIOS 680 can be stored in any computer readable medium, including magnetic storage media, optical storage media, flash memory, random access memory, read only memory, and communications media conveying signals encoding the instructions (e.g., signals from a network). In order to attach computer system 601 to another computer system to copy files over a network, LAN card 630 is coupled to PCI bus 625 and to PCI-to-ISA bridge 635. Similarly, to connect computer system 601 to an ISP to connect to the Internet using a telephone line connection, modem 675 is connected to serial port 664 and PCI-to-ISA Bridge 635.

While the computer system described in FIG. 6 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method for processing database code, said method comprising:
retrieving a SPUFI code;
testing the SPUFI code using an erroneous database;
determining whether the testing is successful; and
updating an actual database based on the determining, the updating creating an changed database.

2. The method as described in claim 1 wherein the updating further comprises:
sending the SPUFI code to a staging area;
requesting a database update to the actual erroneous database;
receiving a response corresponding to the request; and
deciding whether the request is approved based on the receiving.

3. The method as described in claim 2 further comprising:
locking the SPUFI code residing in the staging area from updating.

4. The method as described in claim 1 further comprising;
copying the actual database;
storing the copied actual database as the erroneous database wherein the storing is performed prior to the testing.

5. The method as described in claim 1 wherein the determining further comprises:
registering a request record change quantity, the request record change quantity corresponding to a number of expected changed;
identifying an actual record change quantity, the actual record change quantity corresponding to a number of actual changed records; and
comparing the request record change quantity to the actual record change quantity.

6. The method as described in claim 1 further comprising:
checking the actual changed database for correctness; and
restoring the actual erroneous database in response to the checking.

7. The method as described in claim 1 wherein the testing includes debugging the SPUFI code.

8. An information handling system comprising:
one or more processors;
a memory accessible by the processors;
one or more nonvolatile storage devices accessible by the processors;
a database tool to execute database code, the database tool including:
means for retrieving a SPUFI code;
means for testing the SPUFI code using an erroneous database;
means for determining whether the testing is successful; and
means for updating an actual database based on the determining, the updating creating an changed database.

9. The information handling system as described in claim 8 wherein the means for updating further comprises:
means for sending the SPUFI code to a staging area;
means for requesting a database update to the actual erroneous database;
means for receiving a response corresponding to the request; and
means for deciding whether the request is approved based on the receiving.

10. The information handling system as described in claim 9 further comprising:
means for locking the SPUFI code residing in the staging area from updating.

11. The information handling system as described in claim 8 further comprising;
means for copying the actual database;
means for storing the copied actual database as the erroneous database wherein the storing is performed prior to the testing.

12. The information handling system as described in claim 8 wherein the means for determining further comprises:
means for registering a request record change quantity, the request record change quantity corresponding to a number of expected changed;
means for identifying an actual record change quantity, the actual record change quantity corresponding to a number of actual changed records; and
means for comparing the request record change quantity to the actual record change quantity.

13. The information handling system as described in claim 8 further comprising:
means for checking the actual changed database for correctness; and
means for restoring the actual erroneous database in response to the checking.

14. A computer program product stored in a computer operable media for executing database code, said computer program product comprising:
means for retrieving a SPUFI code;
means for testing the SPUFI code using an erroneous database;
means for determining whether the testing is successful; and
means for updating an actual database based on the determining, the updating creating an changed database.

15. The computer program product as described in claim 14 wherein the means for updating further comprises:
means for sending the SPUFI code to a staging area;
means for requesting a database update to the actual erroneous database;
means for receiving a response corresponding to the request; and
means for deciding whether the request is approved based on the receiving.

16. The computer program product as described in claim 15 further comprising:
means for locking the SPUFI code residing in the staging area from updating.

17. The computer program product as described in claim 14 further comprising;
means for copying the actual database;
means for storing the copied actual database as the erroneous database wherein the storing is performed prior to the testing.

18. The computer program product as described in claim 14 wherein the means for determining further comprises:
means for registering a request record change quantity, the request record change quantity corresponding to a number of expected changed;
means for identifying an actual record change quantity, the actual record change quantity corresponding to a number of actual changed records; and
means for comparing the request record change quantity to the actual record change quantity.

19. The computer program product as described in claim 14 further comprising:
means for checking the actual changed database for correctness; and
means for restoring the actual erroneous database in response to the checking.

20. The computer program product as described in claim 14 wherein the means for testing includes debugging the SPUFI code.
